(19) United States
(12) Patent Application Publication
(10) Pub. No.: US 2025/0387757 A1
(43) Pub. Date: Dec. 25, 2025

(54) TRIETHYLPHOSPHATE/N-METHYLPYRROLIDONE SOLVENT BLENDS FOR MAKING PVDF MEMBRANES

(71) Applicant: Arkema Inc., King of Prussia, PA (US)

(72) Inventors: Walter P. KOSAR, King of Prussia, PA (US); James FITZPATRICK, King of Prussia, PA (US); Gregory S. O'BRIEN, King of Prussia, PA (US); Anthony BONNET, King of Prussia, PA (US)

(21) Appl. No.: 18/878,158

(22) PCT Filed: Jun. 22, 2023
(86) PCT No.: PCT/US2023/025921

§ 371 Date: Dec. 23, 2024

Related U.S. Application Data
(60) Provisional application No. 63/357,180, filed on Jun. 30, 2022.

(51) Int. Cl. B01D 67/00; B01D 69/08; B01D 71/34

(52) U.S. Cl. CPC B01D 67/0011; B01D 69/08; B01D 71/34; B01D 2323/2187; B01D 2323/219

(57) ABSTRACT

The invention discloses a dope solution for membrane fabrication comprising a blend of TEP with NMP as a solvent system in a process to make PVDF membranes, where PVDF resin comprises a homopolymer resin, or a copolymer of VDF and at least one of hexafluoropropylene, trifluoroethylene, chlorotrifluoroethylene, or a tetrafluoropropene.

### FIELD OF THE INVENTION

The present invention relates to a dope solution comprising at least one polymer P, at least one water soluble or hydrogel polymer and a blend of Triethylphosphate/N-methylpyrrolidone, and to the process of making a membrane and the use of this membrane for water treatment.

### BACKGROUND

Polyvinylidene fluoride (PVDF) and polyvinylidene fluoride-co-hexafluoropropylene (PVDF-HFP) copolymers are high performance polymers that are used in a variety of technical applications because of their mechanical properties and their chemical and thermal stability. Polyvinylidene fluoride (PVDF) has limited solubility in many common solvents.

One major technical application is the use of PVDF polymers as raw materials for the production of membranes, for example hollow fiber membranes. The process of producing PVDF membranes includes dissolving PVDF polymers in a solvent, coagulating the PVDF polymer from such solvent and further post-treatment steps. The selection of the solvent is essential to the process and has impact on the properties of the obtained membrane, including but not limited to the membranes' mechanical strength, elasticity, water permeability and pore size.

There are a number of publications describing the use of pure triethylphosphate as a solvent for casting PVDF membranes by the NIPS phase inversion process, for example, Lin et al, Euro. Poly. Jnl., 42, (2006), 158; Liu et al, J. Mem. Sci., 375, (2011), 1; Chang et al, J. Men. Sci., 539, (2017), 295. In patent literature, Chidlow (U.S. Pat. No. 5,565,153) describes use of TEP as a solvent for casting flat sheet PVDF membranes, but without any co-solvent.

Herczeg (US2004050791) teaches the use of NMP to make PVDF membranes in the presence of “non-solvent” additive, where TEP is listed as one of the “non-solvents”. No definition is given in US2004050791 for a “non-solvent”, and no examples with PVDF formulations and NMP-TEP blends are given.

There is a reference to DMAC and TEP for making PVDF hollow fiber membranes (Garcia-Fernández et al., J. Mem. Sci. 468 (2014) 324) but without testing of NMP.

In the field of solvents, there is an ongoing demand for solvents can replace presently used solvents (e.g. NMP) in specific applications. In case of polyvinylidene fluoride (PVDF), the new solvents should be able to prepare solutions that allow a high content of PVDF without turbidity. Regarding membranes made from a new solvent, it is important that membrane quality is achieved; In particular, the water permeability of such membranes should be as high as possible while maintaining strength and elasticity as measured by elongation to break.

It is an object of the present invention to provide a solvent system for polyvinylidene fluoride (PVDF), for the process of making membranes that is less toxic then the presently used solvents. The object of the invention is to reduce the use of hazardous solvents in membrane manufacturing, such as N-Methylpyrrolidone (NMP), N,N-Dimethylacetamide (DMAC), and N,N-Dimethylformamide, DMF. Current solvents used in polymer membrane manufacturing have hazards associated with carcinogenicity or reproductive toxicity. The European Union recently enacted policies to eliminate the use of toxic solvents for in all industrial applications. ((EC) No 1907/2006 and subsequent annexes) Use of safer solvents helps to ensure future production of water filtration membranes. Use of safer solvents reduces manufacturing hazards in membrane production.

The invention provides a solvent system that reduces toxic solvent and does not require substantial reformulation or process adjustments from current methods. Specifically, we are focusing on the non-solvent induced phase separation (NIPS) process for casting membranes using PVDF resin, NMP solvent, and formulation additives such as polyvinylpyrrolidone and polyethylene glycol.

It has been discovered that a blend of triethylphosphate, (TEP) (a less toxic solvent than NMP) and NMP can produce PVDF membranes with comparable properties to membranes made with pure NMP solvent. This blend reduces the use of a hazardous solvent, and because TEP is about half the price of NMP, it offers a substantial cost savings to the manufacturer.

Accordingly, a dope solution to prepare membranes having reduced toxic solvent and a process for making of membranes have been found.

### BRIEF SUMMARY OF INVENTION

We have developed a blend of TEP and NMP that can replace pure NMP as a solvent for preparing PVDF hollow membranes with similar properties. The solvent blend reduces the amount of hazardous solvent (NMP) used in the manufacturing process, and reduces cost due to the lower price of TEP vs NMP.

### ASPECTS OF THE INVENTION

Aspect 1: A dope solution comprising a PVDF resin, a water soluble or hydrogel polymer, and optionally additives, in a solvent, said solvent comprising a blend of triethylphosphate (TEP) and N-methylpyrrolidone (NMP).

Aspect 2: The dope solution of aspect 1, wherein the ratio of TEP to NMP is from 75:25 to 1:99 by weight.

Aspect 3: The dope solution of aspect 1, wherein the ratio of TEP to NMP is from 75:25 to 30:70 by weight.

Aspect 4: The dope solution of aspect 1, wherein the ratio of TEP to NMP is from 70:30 to 50:50, preferably 65:35 to 50:50.

Aspect 5: The dope solution of any combination of aspects 1 to 4, wherein the amount of PVDF is from 12% to 25% by weight, preferably from 18% to 20% based on the total dope solution weight.

Aspect 6: The dope solution of any combination of aspects 1 to 5, wherein the PVDF resin has melt viscosity is from 18 to 45 kilopoise, preferably from 25 to 42 kilopoise.

Aspect 7: The dope solution of any combination of aspects 1 to 6, wherein the PVDF resin comprises a homopolymer resin.

Aspect 8: The dope solution of any combination of aspects 1 to 6, wherein the PVDF resin comprises a copolymer of VDF and at least one of hexafluoropropylene, trifluoroethylene, chlorotrifluoroethylene, or a tetrafluoropropene.

Aspect 9: The dope solution of any combination f aspects 1 to 8, wherein the PVDF polymer comprises a mixture of PVDF polymer with different viscosities.

Aspect 10: The dope solution of any combination of aspects 1 to 9, wherein the optional additive comprises an acrylic resin in an amount of from 0 to 20% by weight, preferably from 1 to 20%, based on the total weight of polymer P and the acrylic resin in the dope solution.

Aspect 11: The dope solution of any combination of aspects 1 to 10, wherein the optional additive comprises an acrylic resin said acrylic resin being selected from the group consisting of a PMMA resin; a PMMA copolymer resin containing acrylic acid ester comonomers; a PMMA copolymer resin containing hydroxyethylmethacrylate comonomer; a PMMA copolymer resin containing methoxy-polyethyleneglycol methacrylate; a PMMA copolymer resin containing polyethylene glycol methacrylate comonomer; a PMMA resin containing zwitterionic functional groups; a PMMA resin containing sulfonic acid groups; and a block copolymer composed of a pure PMMA block and a second block containing both hydrophilic comonomers such as HEMA or PEGMA and hydrophobic comonomers such as an alkylacrylates.

Aspect 12: The dope solution of any combination of aspects 1 to 11, wherein the dope solution has a viscosity of between 50,000 and 250,000 centipoise, preferably between 80,000 and 180,000 cps, as measured by a Brookfield viscometer at 70° C., 50 RPM, with a #7 spindle

Aspect 13: The dope solution of any combination of aspects 1 to 12, wherein the water soluble water hydrogel polymer comprises at least one of polyvinyl pyrrolidone, polyethylene oxide, polyethylene oxide/polypropylene oxide block copolymers or mixtures thereof

Aspect 14: The dope solution of any combination of aspects 1 to 12, wherein the hydrogel polymer comprises at least one of poly-hydroxyethylmethacrylate (poly-HEMA), poly-N-isopropylacrylamide (PNIPAM), poly-ethyleneglycolmethacrylate (PEGMA), crosslinked PVP or copolymers thereof.

Aspect 15: A process for casting a membrane comprising the steps of:
a. Providing a dope solution (PS) comprising a PVDF resin, a water soluble or hydrogel polymer, and optionally additives, in a solvent comprising a triethylphosphate and N-methylpyrrolidone blend where the ratio of TEP to NMP is from 75:25 to 1:99 by weight;
b. degassing the dope solution of step a);
c. Extruding the dope solution,
d. passing the extruded dope solution through a non-solvent bath to form a porous membrane;
e. soaking the porous membrane in water;
f. optionally soaking the porous membrane in a sodium hypochlorite solution (0.5 wt %-7.5 wt %)
g. optionally rinsing of the membrane with fresh water after soaking in sodium hypochlorite.
h. conditioning of the membrane with wetting agents.

Aspect 16: The process of aspect 15, wherein the ratio of TEP to NMP is from 75:25 to 1:99 by weight.

Aspect 17: The process of aspect 15, wherein the ratio of TEP to NMP is from 75:25 to 30:70 by weight.

Aspect 18: The process of aspect 15, wherein the ratio of TEP to NMP is from 70:30 to 50:50, preferably 65:35 to 50:50.

Aspect 19: The process of any combination of aspects 15 to 18, wherein the amount of PVDF is from 12% to 25% by weight, preferably from 18% to 20% based on the total dope solution weight.

Aspect 20: The process of any combination of aspects 15 to 19, wherein the PVDF resin has melt viscosity between 18 and 45 kilopoise, preferably between 25 and 42 kilopoise.

Aspect 21: The process of any combination of aspects 15 to 20, wherein the PVDF resin comprises a homopolymer resin.

Aspect 22: The process of any combination of aspects 15 to 20, wherein the PVDF resin comprises a copolymer of VDF and at least one of hexafluoropropylene, trifluoroethylene, chlorotrifluoroethylene or a tetrafluoropropene.

Aspect 23: The process of any combination of aspects 15 to 22, wherein the PVDF polymer comprises a mixture of PVDF polymer with different viscosities.

Aspect 24: The process of any combination of aspects 15 to 23, wherein the optional additive comprises an acrylic resin additive in an amount of from 0 to 20% by weight, preferably from 1 to 20%, based on the total weight of polymer P and the acrylic additive in the dope solution.

Aspect 25: The process of any combination of aspects 15 to 24, wherein the optional additive comprises an acrylic resin, said acrylic resin being selected from the group consisting of a polymethylmethacrylate (PMMA) resin; a PMMA copolymer resin containing acrylic acid ester comonomers; a PMMA copolymer resin containing hydroxyethylmethacrylate comonomer; a PMMA copolymer resin containing methoxy-polyethyleneglycol methacrylate; a PMMA copolymer resin containing polyethylene glycol methacrylate comonomer; a PMMA resin containing zwitterionic functional groups; a PMMA resin containing sulfonic acid groups; and a block copolymer comprising a pure PMMA block and a second block containing both a hydrophilic comonomer such as HEMA or PEGMA and a hydrophobic comonomer such as an alkylacrylate.

Aspect 26: The process of any combination of aspects 15 to 25, wherein the non-solvent bath described in step d) comprises at least one of: water; a mixture of water and solvents, such as NMP or TEP; a mixture of water and alcohols; mixture of water and glycerol; or a mixture of water and propylene glycol.

Aspect 27: The process of any combination of aspects 15 to 26, wherein the wetting agent are selected from the group consisting of glycerol, propylene glycol, butylene glycol, hexylene glycol, and mixtures or aqueous solutions thereof.

Aspect 28: The process of any combination of aspects 15 to 27, wherein the dope solution is extruded in step c) through a hollow fiber die (tube in orifice design) while injecting a bore liquid in the bore of the membrane.

Aspect 29: The process of aspect 28, wherein the bore liquid comprises a mixture of water, TEP and NMP.

Aspect 30: The process of aspect 29, wherein the water, TEP and NMP is in the ratio of 50 to 80% water 20-40% TEP and 0-25% NMP by weight based on total weight of the water, TEP and NMP; preferably in the ratio of 50-70% water, 15-25% TEP and 5-25% NMP.

Aspect 31: The process of any combination of aspects 15 to 30, further comprising a further step of d2) passing the extruded dope solution through a second non-solvent bath after the first non-solvent bath.

Aspect 32: The process of aspect 31, wherein the second non-solvent bath is selected from the group consisting of water, a mixture of water and surfactant, a mixture of water and glycerol, a mixture of water and propylene glycol, and a mixture of water and polyethylene glycol.

Aspect 33: The process of any combination of aspects 15 to 32, wherein the dope solution is extruded onto a hollow braided fiber.

Aspect 34: The process of any combination of aspects 15 to 33, wherein the dope solution is extruded onto a porous or non-porous support.

Aspect 35: The process of any combination of aspects 15 to 34, wherein the water soluble polymer comprises at least one of polyvinyl pyrrolidone, polyethylene oxide, polyethylene oxide/polypropylene oxide block copolymers or mixtures thereof.

Aspect 36: The process of any combination of aspects 15 to 34, wherein the hydrogel polymer comprises at least one of poly-hydroxyethylmcthacrylate (poly-HEMA), poly-N-isopropylacrylamide (PNIPAM), poly-ethyleneglycolmethacrylate (PEGMA), crosslinked PVP or copolymers thereof.

Aspect 37: A membrane produced by the process of any combination of aspects 15 to 36 wherein said membrane has a pure water permeability between 100 and 1000 LMHB, a mechanical strength in the range of 4.0 to 6.0 MPa, and an elongation to break in the range of 90 to 200%, preferably 100 to 200%.

Aspect 38: The use of the membrane produced by the process of any combination of aspects 13 to 36 for water filtration, including potable water, waste water, industrial process water, and for membrane bio-reactors.

Aspect 39: The use of the dope solution of any combination of aspects 1 to 14 to make a membrane.

Aspect 40: The use of aspect 39, wherein the membrane is used for water filtration, including potable water, waste water, industrial process water, and for membrane bio-reactors.

### BRIEF DESCRIPTION OF THE DRAWINGS

FIG. 1 is a graph of Elongation as a function of % NMP in the dope solutions as referenced in Table 2.

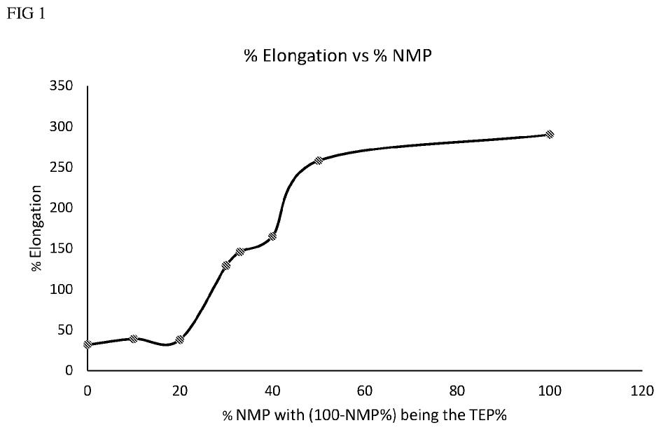

FIG. 2 is a graph of Mechanical strength as a function of % NMP in the dope solutions as referenced in Table 2

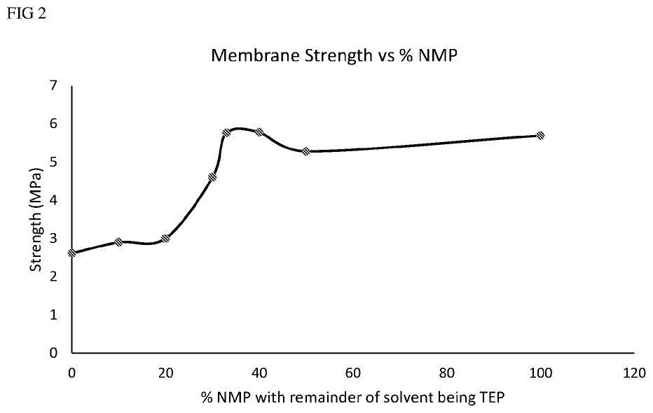

### DETAILED DESCRIPTION OF THE INVENTION

As used herein, unless otherwise indicated, percentages are weight percent, melt viscosity is measured using ASTM 3825 by a capillary rheometry at 100 sec-1 and 232° C. All references cited are incorporated herein by reference.

“Copolymer” is used to mean a polymer having two or more different monomer units, including terpolymers (three different co-monomers) and higher degree polymers (greater than 3 different comonomer). “PVDF” means polyvinylidene fluoride. “Polymer” is used to mean both homopolymer and copolymers. For example, as used herein, “PVDF” and “polyvinylidene fluoride” are used to connote both the homopolymer and copolymers, unless specifically noted otherwise. “Fluoropolymer” is used to mean a polymer comprising fluorinated monomers. The polymers may be homogeneous, heterogeneous, or random, and may have a gradient distribution of co-monomer units.

Hydrogel polymer means a three dimensional crosslinked hydrophilic polymer that does not dissolve in water. The hydrogel polymer can absorb large amounts of water without dissolving, due to physical or chemical crosslinkage of the hydrophilic polymer chains.

The dope solution to prepare the membrane comprises a polymer P, a water soluble or hydrogel polymer, optionally other additives, and a solvent system.

The dope solution to prepare the membrane comprises a polymer P selected from the group of poly vinylidene fluoride (PVDF) homopolymers and copolymers. The term “PVDF polymer” shall include a mixture of different PVDF polymers. The PVDF polymers have a melt viscosity range of has melt viscosity between 18 and 45 kilopoise, preferably between 25 and 42 kilopoise.

The polymer of the invention can be any PVDF fluoropolymers used for forming membranes by the NIPS process. Especially useful fluoropolymers include, but are not limited to the PVDF homo- and copolymers having a majority of monomer units being vinylidene fluoride in combination with comonomers such as hexafluoropropylene, chlorotrifluoroethylene, or vinyl fluoride.

The polyvinylidene fluoride resin (PVDF) composition of the invention comprises either, a homopolymer made by polymerizing vinylidene fluoride (VDF), a copolymer, a terpolymer, a higher polymer of vinylidene fluoride wherein the vinylidene fluoride units comprise typically and preferably greater than 70 percent of the total weight of all the monomer units in the polymer, and more preferably, comprise greater than 75 percent of the total weight of the units. Copolymers, terpolymers and higher polymers of vinylidene fluoride may be made by reacting vinylidene fluoride with one or more monomers from the group consisting of vinyl fluoride, trifluoroethene, tetrafluoroethene; tetrafluoropropene such as 2,3,3,3-tetrafluoropropene, E-1,3,3,3-tetrafluoropropene, Z-1,3,3,3-tetrafluoropropene, 1,1,2,3-tetrafluoropropene, 1,2,3,3-tetrafluoropropene, 1,1,3,3-tetrafluoropropene, chlorotetrafluoropropene; 3,3,3-trifluoro-1-propene, 1,2,3,3,3 pentafluoropropene, one or more of partly or fully fluorinated alpha-olefins such as 3,3,3,4,4-pentafluoro-1-butene, hexafluoropropene, trifluoromethyl-methacrylic acid, trifluoromethyl methacrylate, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro (1,3 dioxole) and perfluoro (2,2-dimethyl-1,3-dioxole), allylic, partly fluorinated allylic, or fluorinated allylic monomers, such as 2-hydroxyethyl allyl ether or 3-allyloxypropanediol, ethene, propene. Preferred copolymers or terpolymers are formed with one or more of vinyl fluoride, trifluoroethene, tetrafluoroethene (TFE), and hexafluoropropene (HFP). Most preferred copolymers are formed with hexafluoropropene (HFP). One preferred PVDF is Kynar®PVDF by Arkema.

While an all fluoromonomer containing copolymer is preferred, non-fluorinated monomers such as vinyl acetate, methacrylic acid, and acrylic acid, may also be used to form copolymers, at levels of up to 5 weight percent based on the polymer solids.

Preferred copolymers are of VDF comprising from about 70 to about 99 weight percent VDF monomer units, and correspondingly from about 1 to about 30 wt percent HFP monomer units; and from about 70 to 99 weight percent VDF, and correspondingly from about 1 to 30 weight percent trifluoroethylene monomer units.

Mixtures of polyvinylidene fluoride polymers is also envisioned as part of the invention, including functionalized fluoro-polymers with non-functionalized polymers, PVDF homopolymers with PVDF-HFP copolymers, and PVDF polymers having different melt viscosities.

Preferably, the dope solution comprises 10 to 30 weight percent of polymer P, more preferably 12 to 25 weight percent, most preferably 18-22 wt % based on the total weight of the dope solution.

### Water Soluble/Hydrogel Polymers

The water soluble or hydrogel polymer may help to adjust the viscosity of the dope solution. The main purpose of these hydrophilic additives is to support the formation of the pores and impart residual hydrophilicity to the membranes.

The water soluble polymer may be any known water soluble polymer. Preferred water soluble polymers are selected from the group of polyvinyl pyrrolidone (PVP); polyethylene glycol with a molecular weight of between 200 and 1000 Mw; and polyalkylene oxides with a molar mass of 4000 g/mol or higher. Preferred water soluble polymers include polyvinyl pyrrolidone, polyethylene oxide, polyethylene oxide/polypropylene oxide block copolymers and mixtures thereof. Preferred water soluble polymers are polyethylene glycol and polyvinylpyrrolidone. A very preferred water soluble polymer is polyvinyl pyrrolidone.

Preferred hydrogel polymers may be selected from known examples, including poly-hydroxyethylmethacrylate (poly-HEMA), poly-N-isopropylacrylamide (PNIPAM), poly-ethyleneglycolmethacrylate (PEGMA), high K value PVP, crosslinked PVP and copolymers thereof.

When the dope solution comprises 10 to 30 weight percent of polymer P, the amount of water soluble or hydrogel polymer can be from 1 to 22 wt %, based on the total weight of the dope solution.

In a preferred embodiment, the dope solution contains 12 to 25 wt % of polymer P, and 2 to 20 wt % of the water soluble or hydrogel polymer, based on the total weight of the dope solution. In a more preferred embodiment, the dope solution contains 18-20 wt % of polymer P and 8-16 wt % of the water soluble or hydrogel polymer, based on the total weight of the dope solution.

In one embodiment the amount of PVP additive is preferably 10-16%, preferably 14-15% based on the total weight of dope solution;

The polyvinyl pyrrolidone preferably has a K value of from 10 to 120. Preferably at least one PVP present in the composition is has a K value of from 12 to 60. One or more different K value polyvinyl pyrrolidones can be used. The polyvinyl pyrrolidones can be used in combination such as for example a combination of K15 with a K30, or a K15 with a K60, or a K15 with a K90, or a K30 with a K60. A given K values roughly correspond to a weight average Molecular weight (using GPC/MALLS). Generally PVP having a K value of K30 has a weight average molecule weight in the range of 40,000 to 80,000 g/mole, K60 generally indicates a Weight average molecular weight in the range of 250,000 to 500,000 g/mole, K90 generally indicates a weight average molecular weight in the range of 1 to 1.4 million g/mole. K15 is generally in the range of 7,000 to 20,000 g/mole. By “K value’ is meant Fikentscher K value (1000 k) as defined by H. Fikentscher—Cellulosechemie 13, 58-64, 71-4 (1932). (U.S. Pat. No. 2,706,701) PVP polymers are available as commercial products such as Luvitec®PVP (from BASF) or Plasdone™, Povidone, PVP K series (all from Ashland) and are sold referencing K value as an indication of molecular weights.

In some embodiments the amount of polyethylene glycol, PEG, is 0-10% by weight based on the total weight of the dope solution;

In some embodiments PEG is used and preferably has a molecular weight of between 200 and 1000 Mw. In some embodiments the molecular weight can be higher

### Additives

In one embodiment an optional additive is an acrylic resin in an amount of from 0-20% by weight, preferably 1-20%, based on the total weight of polymer P and the acrylic resin in the dope solution.

The optional the acrylic resin can be any one or more of a PMMA resin; a PMMA copolymer resin containing acrylic acid ester comonomers; a PMMA copolymer resin containing hydroxyethylmethacrylate comonomer; a PMMA copolymer resin containing methoxy-polyethyleneglycol methacrylate; a PMMA copolymer resin containing polyethylene glycol methacrylate comonomer; a PMMA resin containing zwitterionic functional groups such as sulfobetainemethacrylate; a PMMA resin containing sulfonic acid groups; a block copolymer composed of a pure PMMA block and a second block containing both hydrophilic comonomers such as HEMA or PEGMA and hydrophobic comonomers such as alkylacrylates.

Other additives can include (but are not limited to), inorganic salts such as lithium chloride, magnesium chloride, ferrous chloride, and aluminum chloride; quaternary ammonium salts; propylene glycol, glycerol, organic acids, molecular sieves, silica, aluminum oxide, and activated carbon.

### Solvent System

The solvent system comprises a blend of Triethylphosphate (TEP)/N-methylpyrrolidone (NMP). Preferably the blend of Triethylphosphate (TEP)/N-methylpyrrolidone (NMP) comprises a ratio of TEP:NMP is from 75:25 to 1:99 by weight, preferably 75:25 to 30:70, more 70:30 to 50:50. In some embodiments the ratio is from 65:35 to 50:50 by weight.

A preferred embodiment is an blend range of TEP:NMP ranging from 75:25 and below. At ratios higher than 75:25, (for example 90 TEP:10 NMP) the mechanical strength and elongation declines.

The dope solution may comprise optional cosolvents in addition to the Triethylphosphate/N-methylpyrrolidone blend, hereinafter referred to as co-solvents.

Preferred are co-solvents that are miscible with the Triethylphosphate/N-methylpyrrolidone blend. Suitable co-solvents are, for example, selected from, dimethylformamide, dimethyl sulfoxide, sulfolane, N-ethyl-2-pyrrolidone, N-n-butyl-2-pyrrolidone, N,N-dimethyl-2-hydroxypropanoic amide N,N, diethyl-2-hydroxypropanoic amide, ethyllactate, methyllactate, Cyrene™ (dehydroglucosenone), ethyllevulinate, and 2-pyrrolidone.

Total solvent (TEP, NMP and cosolvent(s)) in the dope solution is generally between 50 and 85 weight percent of the total dope solution weight, preferably 55 to 75 wt percent of the total dope solution.

In a preferred embodiment no more than 15 wt % of the dope solution is a co-solvent based on weight of the total amount of all solvents of the dope solution.

In a most preferred embodiment no co-solvent is used in the dope solution and the Triethylphosphate/N-methylpyrrolidone blend is the only solvent system used.

### Preparation of the Dope Solution

The dope solution may be prepared by adding the polymer P and the water-soluble polymer and/or hydrogel polymer, in any order, to the Triethylphosphate (TEP)/N-methylpyrrolidone (NMP) blend and dissolving polymer P and the water soluble polymer and/or hydrogel polymer according to any process known in the art. The dissolution process may be supported by increasing the temperature of the dope solution and/or by mechanical operations like stirring.

In one general method, the components are blended with an overhead mixer at preferably at 30-300 rpm and preferably while heating to a temperature of between 7° and 120° C. for four to 12 hours.

Preferably, the final dope solution has a final viscosity of between 50,000 and 250,000 centipoise as measured by a Brookfield viscometer at 70° C., 50 RPM, with a #7 spindle, preferably between 80,000 and 180,000 eps.

### Process of Making a Membrane

In the context of this application, a membrane shall be understood to be a semipermeable structure capable of separating two fluids or separating molecular and/or ionic components or particles from a liquid. A membrane acts as a selective barrier, allowing some particles, substances or chemicals to pass through, while retaining others. The membrane may have various geometries such as flat sheet, spiral wound, tubular, single bore hollow fiber, multiple bore hollow fiber, or reinforced hollow fiber.

Membranes may be produced according to a process comprising providing a dope solution comprising polymer P, water soluble polymer or hydrogel polymer, and the solvent blend, casting the membrane by extruding the dope solution, passing the extruded dope solution through a non-solvent bath/coagulant and optionally oxidizing and washing the obtained membrane.

Preferably, the process for casting a membrane comprising the steps of:
a. Providing a dope solution (DS) comprising a PVDF resin, a water soluble or hydrogel polymer, and optionally additives, in a solvent comprising a triethylphosphate and N-methylpyrrolidone blend;
b. degassing the dope solution of step a);
c. Extruding the dope solution,
d. coagulating the dope solution by passing the extruded dope solution of step c through a non-solvent bath to form a porous membrane;
e. soaking the porous membrane in an aqueous solution;
f. Optionally soaking the porous membrane in a sodium hypochlorite solution (0.5%-7.5%) for 4-24 hours at a temperature of 20-50° C. followed by rinsing of the porous membrane with fresh water after the soaking in sodium hypochlorite;
g. Optionally soaking in an alcohol solution;
h. Conditioning of the fibers with wetting agents.

The dope solution in step a) corresponds to the dope solution described above. The main purpose of the water solution polymer is to support the formation of the pores. The water soluble or hydrogel polymer may also help to adjust the viscosity of the dope solution. In the coagulation step d) the water soluble polymer becomes distributed in the coagulated membrane and thus becomes the place holder for pores.

Degassing can be done at an elevated temperature or at room temperature, preferably between 50 to 80° C.

In step d) the dope solution is contacted with a non-solvent bath also referred to as a coagulant. In this step coagulation of the polymer P occurs and the membrane structure is formed.

In step f) the solution can be at ambient temperature or at an elevated temperature, preferably from 20 C to 50° C.

Hollow fiber membranes in accordance with the invention may be assembled in hollow fiber membrane modules by adaptation of any of such assembly techniques or methods known in the art. Procedures for fabricating such modules using hollow member fibers are well known and are described, for example, in the following publications, each of which is incorporated herein by reference in its entirety for all purposes: U.S. Pat. Nos. 8,728,316; 8,679,337; 8,636,904; 8,307,991; 8,225,941; 8,042,695; 7,749,381; 7,704,393; 7,316,754; 7,160,455; 6,682,652; and 6,331,248; U.S. Pat. Application Pub. No. 2003/0038075; and Mat et al., Current Opinion in Chemical Engineering, Vol. 4, May 2014, pp. 18-24.

The process for casting a hollow fiber membrane from the dope comprises extruding the dope through a hollow fiber die (tube in orifice design) while injecting a mixed solvent in the bore of the membrane and drawing the fiber through a non-solvent bath. In general, the membrane is then collected onto collection reel.

For the process of the invention the bore liquid is preferably a mixture of water, TEP and NMP, preferably in the ratio (by weight) of water 50-80%, TEP 20-40%, NMP 0-25%, more preferably in the ratio 50-70% water, 15-25% TEP, 5-25% NMP.

In some embodiments, the dope is heated to between 4° and 80° C.

In some embodiments, the bore liquid is heated to between 4° and 60° C.

In some embodiments, the non-solvent bath is pure water.

In some embodiments the water non-solvent bath is heated to between 4° and 60° C.

In some embodiments, the hollow fiber die is heated between 4° and 90° C., preferably heated between 5° and 70° C.

In some embodiments, the fiber is immersed from 2-20 meters in the non-solvent bath.

The process of the invention may optionally have a second non-solvent bath following the first non-solvent bath.

In some embodiments, the second non-solvent bath is at room temperature.

The second non-solvent bath (or single non-solvent bath if used) may be selected from the group consisting of pure water, a mixture of water and surfactant, a mixture of water and glycerol, a mixture of water and propylene glycol, or a mixture of water and polyethylene glycol.

### Non Solvent

The polymer P should have low solubility in the non-solvent/coagulant. Suitable non-solvent bath/coagulants are, for example, liquid water, water vapor, alcohols, glycols, glycerol, or mixtures thereof.

Suitable alcohols are, for example, mono-, di- or trialkanols selected from the group of the group of C2-C4 alkanol, C2-C4 alkanediol, C3-C4 alkanetriol, polyethylene oxide with a molar mass of 100 to 1000 g/mol as they can be used as additives in the inventive dope solution. Preferred mixtures of the non-solvents are mixtures comprising liquid water and alcohols, more preferably are mixtures comprising liquid water and the alcohols that were optionally used as additive in the inventive dope solution. A preferred non-solvent is liquid water.

A flat sheet membrane can be made using the dope solution and the method of the present invention. The dope solution is cast onto a support which is then contacted with the bath.

In a preferred embodiment process steps e)-h) are performed. Oxidation as well as washing is performed in order to remove the water soluble polymer and to form the pores. Oxidation is followed by a washing step.

For oxidation any oxidant may be used. Preferred is a water soluble oxidant such as sodium hypochlorite or hydrogen peroxide.

The resulting membranes preferably have high tensile strength—greater than 3.5 MPa, preferably equal to or greater than 4 MPa and high elongation—equal to or greater than 95%, preferably equal to or greater than 100% elongation and a PWP (pure water permeation) of greater than 190 LMHB (Liters per hour-meter square-bar).

The membranes obtained by the process of the invention may be used for any separation purpose, for example water treatment applications, treatment of industrial or municipal waste water, desalination of sea or brackish water, dialysis, plasmolysis, food processing.

### EXAMPLES

### Abbreviations and Compounds Used in the Examples

PWP pure water permeation
NMP N-methyl-2-pyrrolidone
TEP Triethylphosphate

### Preparation of Dope Solution for Membrane Formation

### Example 1: 50:50 TEP-NMP

Kynar® MG15 (PVDF homopolymer resin, 35-39 kpoise, 57 g)(available from Arkema Inc.) and polyvinylpyrrolidone (K30 grade, 45 g), were weighed out into a 16 oz mixing jar. Triethylphosphate (99 g) and N-methylpyrrolidone (99 g) were added to the powders. A mixer blade was inserted into the jar and secured in place with a cover. The mixture was stirred with an overhead stirrer at 75 rpm while heating with a heating mantle to 95° C. for six hours. A clear yellow viscous solution resulted. The jar was sealed with a cap and placed in the oven overnight at 70° C. The viscosity of this solution was measured to be 126,000 cps.

TABLE 1

| | Triethyl- | | N-methyl- | | | | |
|---|---|---|---|---|---|---|---|
| | phosphate | | pyrrolidone | | Ratio of | Solution | |
| Example | (grams) | | (grams) | | TEP:NMP | Viscosity | |
| 1 | 99 | | 99 | | 50:50 | 126000 | cps |
| 2 | 138.6 | g | 59.4 | g | 70:30 | 146000 | cps |
| 4 | 118.8 | g | 79.2 | g | 60:40 | 129000 | |
| 5 | 132.7 | | 65.3 | | 67:33 | 159000 | |
| 3 Comparative | 158.4 | g | 39.6 | g | 80:20 | 148,000 | cps |
| 6 Comparative | 178.2 | g | 19.8 | g | 90:10 | 184,000 | cps |

| | | | | | | |
|---|---|---|---|---|---|---|
| 7 Comparative - | 0 | 198 | g | 0:100 | 98,560 | cps. |

| NMP | | | | | | |
|---|---|---|---|---|---|---|
| 8 Comparative - | 198 | g | 0 | 100:0 | 180,000 | cps |

100% TEP

### Example 2: 70:30 TEP-NMP

Same as Example 1 except for the amount of Triethylphosphate and N-methylpyrrolidone was changed to the amount in table 1.

### Example 3: 80:20 TEP-NMP—Comparative

Same as Example 1 except for the amount of Triethylphosphate and N-methylpyrrolidone was changed to the amount in table 1.

### Example 4: 60:40 TEP-NMP

Same as Example 1 except for the amount of Triethylphosphate and N-methylpyrrolidone was changed to the amount in table 1.

### Example 5: 67:33 TEP-NMP

Same as Example 1 except for the amount of Triethylphosphate and N-methylpyrrolidone was changed to the amount in table 1.

### Example 6: 90:10 TEP-NMP (Comparative)

Same as Example 1 except for the amount of Triethylphosphate and N-methylpyrrolidone was changed to the amount in table 1.

### Example 7: 100% NMP (Comparative)

Same as Example 1 except for the solvent is 100% N-methylpyrrolidone was changed to the amount in table 1.

### Example 8: 100% TEP (Comparative)

Same as Example 1 except for using 100% TEP solvent.

### Casting of Membrane and Post Treatment

### Hollow Fiber Casting

The following procedure was applied to casting all the formulations described above. The casting line consisted of temperature controlled tanks for holding the membrane formulation (dope) and bore fluid. The dope and bore fluid were pumped using gear pumps for high precision dispensing. The membrane formulation was loaded into a temperature controlled dope tank (approximately 70° C.) and allowed to set 15 minutes before casting. The dope transfer line to the spinneret is maintained at same temperature as the dope tank. The spinneret was heated independently to about the same temperature. The bore fluid was loaded into the bore fluid tank, temperature controlled to approximately 60° C. The water non-solvent bath was heated to approximately 60° C. The take-up speed on the collection reel was approximately 12 m/min. The take-up reel was immersed in room temperature water bath to help wash the fibers.

After casting the membranes, they were soaked in water overnight, then treated with sodium hypochlorite solution (1.5%) at 45° C. for 6 hours, followed by overnight soaking at room temperature. The membranes were then rinsed twice with fresh water before testing permeability.

### Membrane Testing Results

Mechanical testing was done on an Instron 4201 universal test frame (following ASTM D638) equipped with a fiber holder designed to wrap fibers around a spool. This prevented damage to the delicate hollow fibers by standard tensile bar grips. The gap spacing was 100 mm with a strain rate of 50 mm min⁻¹. Fibers were tested while wet with water.

To test pure water permeability, 5 loops of membrane approximately 35 cm long each were potted in a test module with epoxy resin. The water flow was measured at 0.5 bar, with a 15 minute purge prior to reading, then normalized to l·m⁻²·h⁻¹·bar⁻¹, LMHB.

Table 2 shows the permeability and mechanical properties of the casted formulations

TABLE 2
Membrane Properties vs NMP Content

| | | | | Perme- |
|---|---|---|---|---|
| Formulation | | % Elon- | Strength | ability |
| example | % NMP | gation | (MPa) | (LMHB) |
| Comparative 7 | 100 | 290 | 5.69 | 218 |
| 100% NMP | | | | |
| 1 | 50 | 258 | 5.28 | 209 |
| 4 | 40 | 165 | 5.78 | 210 |
| 5 | 33 | 146 | 5.76 | 273 |
| 2 | 30 | 129 | 4.6 | 309 |
| Comparative 3 | 20 | 38 | 3 | 344 |
| Comparative 6 | 10 | 39 | 2.9 | 365 |
| Comparative 8 100% TEP | 0 | 32 | 2.61 | 209 |

### The Data of Table

When testing for properties of the membranes made using the solvent blend it was surprising to learn that a membrane with high mechanical strength and high elongation can be obtained at levels greater than 50% TEP. Using TEP as the only solvent (100% TEP) resulted in poor elongation and mechanical strength. We have found that replacing up to 70% of the NMP with TEP, the obtained membranes have an elongation of at least 95%, preferable 100% and a mechanical strength of at least 3.5 preferable at least 4 MPa and a LMHB of greater than 190 which is comparable or greater than a membrane with 100% NMP.

1. A dope solution comprising a PVDF resin, a water soluble or hydrogel polymer, and optionally additives, in a solvent, said solvent comprising a blend of triethylphosphate (TEP) and N-methylpyrrolidone (NMP).

2. (canceled)

3. The dope solution of claim 1, wherein the ratio of TEP to NMP is from 75:25 to 30:70 by weight.

4. (canceled)

5. The dope solution of claim 1, wherein the amount of PVDF is from 12% to 25% by weight based on the total dope solution weight.

6. The dope solution of claim 1, wherein the melt viscosity of the PVDF resin is from 18 to 45 kilopoise.

7. The dope solution of claim 1, wherein the PVDF resin comprises a homopolymer resin.

8. The dope solution of claim 1, wherein the PVDF resin comprises a copolymer of VDF and at least one of hexafluoropropylene, trifluoroethylene, chlorotrifluoroethylene, or a tetrafluoropropene.

9. The dope solution of claim 1, wherein the PVDF polymer comprises a mixture of PVDF polymer with different viscosities.

10. The dope solution of claim 1, wherein the optional additive comprises an acrylic resin in an amount of from 0 to 20% by weight, based on the total weight of polymer P and the acrylic resin in the dope solution.

11. (canceled)

12. (canceled)

13. The dope solution of claim 1, wherein the water soluble water or hydrogel polymer comprises at least one of polyvinyl pyrrolidone, polyethylene oxide, polyethylene oxide/polypropylene oxide block copolymers or mixtures thereof

14. (canceled)

15. A process for casting a membrane comprising the steps of:
a) Providing a dope solution (PS) comprising a PVDF resin, a water soluble or hydrogel polymer, and optionally additives, in a solvent comprising a triethylphosphate and N-methylpyrrolidone blend where the ratio of TEP to NMP is from 75:25 to 1:99 by weight;
b) degassing the dope solution of step a);
c) Extruding the dope solution, d) passing the extruded dope solution through a non-solvent bath to form a porous membrane;
e) soaking the porous membrane in water;
f) optionally soaking the porous membrane in a sodium hypochlorite solution (0.5 wt %-7.5 wt %)
g) optionally rinsing of the membrane with fresh water after soaking in sodium hypochlorite;
h) conditioning of the membrane with wetting agents.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. The process of claim 15, wherein the dope solution is extruded in step c) through a hollow fiber die (tube in orifice design) while injecting a bore liquid in the bore of the membrane.

29. The process of claim 28, wherein the bore liquid comprises a mixture of water, TEP and NMP.

30. The process of claim 29, wherein the water, TEP and NMP are in the ratio of 50 to 80% water, 20-40% TEP and 0-25% NMP, by weight based on total weight of the water, TEP and NMP.

31. (canceled)

32. (canceled)

33. The process of claim 15, wherein the dope solution is extruded onto a hollow braided fiber.

34. The process of claim 15, wherein the dope solution is extruded onto a porous or non-porous support.

35. (canceled)

36. (canceled)

37. The membrane produced by the process of claim 15, wherein said membrane has a pure water permeability between 100 and 1000 LMHB, a mechanical strength in the range of 4.0 to 6.0 MPa, and an elongation to break in the range 90 to 200%.

38. (canceled)

39. (canceled)

40. (canceled)
